(19) United States
(12) Patent Application Publication
(10) Pub. No.: US 2025/0368570 A1
(43) Pub. Date: Dec. 4, 2025

(54) Cellular Compatible Coating

(71) Applicant: Virto Flat Glass LLC, Cheswick, PA (US)

(72) Inventors: Alexandra Gordienko, Natrona Heights, PA (US); Farzad Fareed, San Diego, CA (US); Patrick Fisher, Pittsburgh, PA (US)

(21) Appl. No.: 19/220,192

(22) Filed: May 28, 2025

Related U.S. Application Data
(60) Provisional application No. 63/652,748, filed on May 29, 2024.

(51) Int. Cl. C03C 17/36

(52) U.S. Cl. CPC C03C 17/366; C03C 2217/212; C03C 2217/228; C03C 2217/27; C03C 2217/734

(57) ABSTRACT

An article including a glass substrate having a No. 1 surface and a No. 2 surface opposite the No. 1 surface and a non-conductive solar control coating on the No. 1 surface or the No. 2 surface comprising a plurality of dielectric layers is provided. The non-conductive solar control coating comprises an alternating stack of high refractive index material layers and low refractive index material layers.

### CROSS REFERENCE TO RELATED APPLICATIONS

This application claims priority to U.S. Provisional Application No. 63/652,748, filed May 29, 2024, the disclosure of which is incorporated by reference in its entirety.

### BACKGROUND OF INVENTION

### Field of Invention

The present application relates generally to transparent coated articles and, more specifically, to glass articles having a non-conductive solar control coating that includes an alternating stack of high refractive index material layers and low refractive index material layers.

### Technical Considerations

Many glass structures, such as automotive glass structures, include coatings that block radiation in the ultraviolet (UV) and infrared (IR) wavelengths to reduce heat within the spaces housed by the glass structures. However, these coatings include reduction in cellular compatibility, as many signals in the 5G range are, for example, disrupted by the presence of materials blocking ultraviolet and infrared radiation.

These coated automotive glass structures, such as for windshield and front sidelight areas in the United States, also have a visible light transmission is typically greater than or equal to 70%. For privacy areas, such as rear seat sidelights and rear windows, the visible light transmission can be less than that for windshields, such as less than 70%.

Therefore, it would be desirable to provide a transparency that blocks both UV and IR wavelengths, while having cellular compatibility and a visible light transmission of greater than or equal to 70%.

### SUMMARY OF THE INVENTION

The invention is directed to an article. The article comprises a glass substrate having a No. 1 surface and a No. 2 surface opposite the No. 1 surface and a non-conductive solar control coating on the No. 1 surface or the No. 2 surface comprising a plurality of dielectric layers. The non-conductive solar control coating comprises an alternating stack of high refractive index material layers and low refractive index material layers.

In another embodiment, the invention is directed to an article comprising a glass substrate having a No. 1 surface and a No. 2 surface opposite the No. 1 surface and a non-conductive solar control coating on the No. 1 surface or the No. 2 surface comprising a plurality of dielectric layers, wherein the coating comprises an alternating stack of high refractive index material layers and low refractive index material layers comprising a first dielectric layer having a high refractive index, a second dielectric layer over the first dielectric layer having a low refractive index, a third dielectric layer over the second dielectric layer having a high refractive index, a fourth dielectric layer over the third dielectric layer having a low refractive index, a fifth dielectric layer over the fourth dielectric layer having a high refractive index, a sixth dielectric layer over the fifth dielectric layer having a low refractive index, a seventh dielectric layer over the sixth dielectric layer having a high refractive index, an eighth dielectric layer over the seventh dielectric layer having a low refractive index, and a ninth dielectric layer over the eighth dielectric layer having a high refractive index.

In another embodiment, the invention is directed to an article comprising a glass substrate having a No. 1 surface and a No. 2 surface opposite the No. 1 surface and a non-conductive solar control coating on the No. 1 surface or the No. 2 surface comprising a plurality of dielectric layers, wherein the coating comprises an alternating stack of high refractive index material layers and low refractive index material layers comprising a first dielectric layer having a medium refractive index, a second dielectric layer over the first dielectric layer having a high refractive index, a third dielectric layer over the second dielectric layer having a low refractive index, a fourth dielectric layer over the third dielectric layer having a high refractive index; a fifth dielectric layer over the fourth dielectric layer having a low refractive index, a sixth dielectric layer over the fifth dielectric layer having a high refractive index, a seventh dielectric layer over the sixth dielectric layer having a low refractive index, an eighth dielectric layer over the seventh dielectric layer having a high refractive index, a ninth dielectric layer over the eighth dielectric layer having a low refractive index, a tenth dielectric layer over the ninth dielectric layer having a high refractive index, a eleventh dielectric layer over the tenth dielectric layer having a low refractive index, a twelfth dielectric layer over the eleventh dielectric layer having a high refractive index, a thirteenth dielectric layer over the twelfth dielectric layer having a medium refractive index, and a fourteenth dielectric layer over the thirteenth dielectric layer having a high refractive index.

In another embodiment, the invention is directed to an article comprising a glass substrate having a No. 1 surface and a No. 2 surface opposite the No. 1 surface and a non-conductive solar control coating on the No. 1 surface or the No. 2 surface comprising a plurality of dielectric layers, wherein the coating comprises an alternating stack of low refractive index material layers and medium refractive index material layers comprising a first dielectric layer having a low refractive index, a second dielectric layer over the first dielectric layer having a medium refractive index, a third dielectric layer over the second dielectric layer having a low refractive index, a fourth dielectric layer over the third dielectric layer having a medium refractive index, a fifth dielectric layer over the fourth dielectric layer having a low refractive index, a sixth dielectric layer over the fifth dielectric layer having a medium refractive index, a seventh dielectric layer over the sixth dielectric layer having a low refractive index, an eighth dielectric layer over the seventh dielectric layer having a medium refractive index, and a ninth dielectric layer over the eighth dielectric layer having a low refractive index.

In another embodiment, the invention is directed to an article comprising a glass substrate having a No. 1 surface and a No. 2 surface opposite the No. 1 surface and a non-conductive solar control coating on the No. 1 surface or the a No. 2 surface comprising a plurality of dielectric layers, wherein the coating comprises an alternating stack of medium refractive index material layers and high refractive index material layers comprising a first dielectric layer having a medium refractive index, a second dielectric layer over the first dielectric layer having a high refractive index, a third dielectric layer over the second dielectric layer having a medium refractive index, a fourth dielectric layer over the third dielectric layer having a high refractive index, a fifth dielectric layer over the fourth dielectric layer having a medium refractive index, a sixth dielectric layer over the fifth dielectric layer having a high refractive index, a seventh dielectric layer over the sixth dielectric layer having a medium refractive index, an eighth dielectric layer over the seventh dielectric layer having a high refractive index, and a ninth dielectric layer over the eighth dielectric layer having a medium refractive index.

### BRIEF DESCRIPTION OF THE DRAWINGS

The disclosure will be described with reference to the following drawing figures wherein like reference numbers identify like parts throughout.

FIGS. 1A and 1B are sectional views (not to scale) of coated articles according to an example of the present invention.

FIGS. 2A and 2B are sectional views (not to scale) of coated articles according to an example of the present invention.

FIGS. 3A and 3B are sectional views (not to scale) of coated articles according to an example of the present invention.

FIGS. 4A and 4B are sectional views (not to scale) of coated articles according to an example of the present invention.

FIGS. 5A and 5B are sectional views (not to scale) of coated articles according to an example of the present invention.

FIGS. 6A and 6B are sectional views (not to scale) of coated articles according to an example of the present invention.

FIGS. 7A and 7B are sectional views (not to scale) of coated articles according to an example of the present invention.

FIG. 8 is a sectional view (not to scale) of an exemplary transparency having a coating of the invention.

FIG. 9 is a sectional view (not to scale) of an exemplary transparency having a coating of the invention.

### DETAILED DESCRIPTION

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “approximately” or “about”. Accordingly, unless indicated to the contrary, the numerical values set forth in the following specification and claims may vary depending upon the desired properties sought to be obtained by the present disclosure. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate.

As used herein, the terms “polymer” or “polymeric” include oligomers, homopolymers, copolymers, and terpolymers, e.g., polymers formed from two or more types of monomers or polymers.

The terms “visible region” or “visible light” refer to electromagnetic radiation having a wavelength in the range of 380 nm to 800 nm. The terms “infrared region” or “infrared radiation” refer to electromagnetic radiation having a wavelength in the range of greater than 800 nm to 100,000 nm. The terms “ultraviolet region” or “ultraviolet radiation” mean electromagnetic energy having a wavelength in the range of 300 nm to less than 380 nm.

Additionally, all documents, such as, but not limited to, issued patents and patent applications, referred to herein are to be considered to be “incorporated by reference” in their entirety.

As used herein, the term “film” refers to a coating region of a desired or selected coating composition. A “layer” can comprise one or more “films”, and a “coating” or “coating stack” can comprise one or more “layers”. The terms “metal” and “metal oxide” include silicon and silica, respectively, as well as traditionally recognized metals and metal oxides, even though silicon conventionally may not be considered a metal. Thickness values, unless indicated to the contrary, are geometric thickness values.

The discussion of the invention may describe certain features as being “particularly” or “preferably” within certain limitations (e.g., “preferably”, “more preferably”, or “most preferably”, within certain limitations). It is to be understood that the invention is not limited to these particular or preferred limitations but encompasses the entire scope of the disclosure.

Weight percentages (wt. %) of the metal oxides, metal alloys, metal nitrides, or metal oxynitrides, as used herein, are based on the total weight of the metal components and exclude the weight of any oxide, nitride, or oxynitride components.

The invention is directed to an article. The article comprises a glass substrate having a No. 1 surface and a No. 2 surface opposite the No. 1 surface and a non-conductive solar control coating on the No. 1 surface or the No. 2 surface comprising a plurality of dielectric layers. The non-conductive solar control coating comprises an alternating stack of high refractive index material layers and low refractive index material layers.

The article 10 includes a glass substrate 12, such as a soda-lime glass, soda-lime-silicate glass, borosilicate glass, or leaded glass. In yet another example, the article 10 comprises a tempered glass substrate 12. The glass substrate 12 of the article 10 has a No. 1 surface 14 and a No. 2 surface 16 opposite the No. 1 surface 14. The glass substrate 12 can be a clear glass substrate. By “clear glass” is meant non-tinted or non-colored glass. Alternatively, the glass substrate 12 can be tinted or otherwise colored glass. The glass substrate 12 can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. The ribbon is then cut and/or shaped and/or heat treated as desired. Examples of float glass processes are disclosed in U.S. Pat. Nos. 4,466,562 and 4,671,155.

The glass substrate 12 may comprise clear float glass or can be tinted or colored glass. The glass substrate 12 can be of any desired dimensions, e.g., length, width, shape, or thickness. However, it is to be understood that the specifically disclosed exemplary embodiments are presented simply to explain the general concepts of the invention, and that the invention is not limited to these specific exemplary embodiments. Additionally, while a typical “transparency” can have sufficient visible light transmission such that materials can be viewed through the transparency, in the practice of the invention, the “transparency” need not be transparent to visible light but may be translucent or opaque.

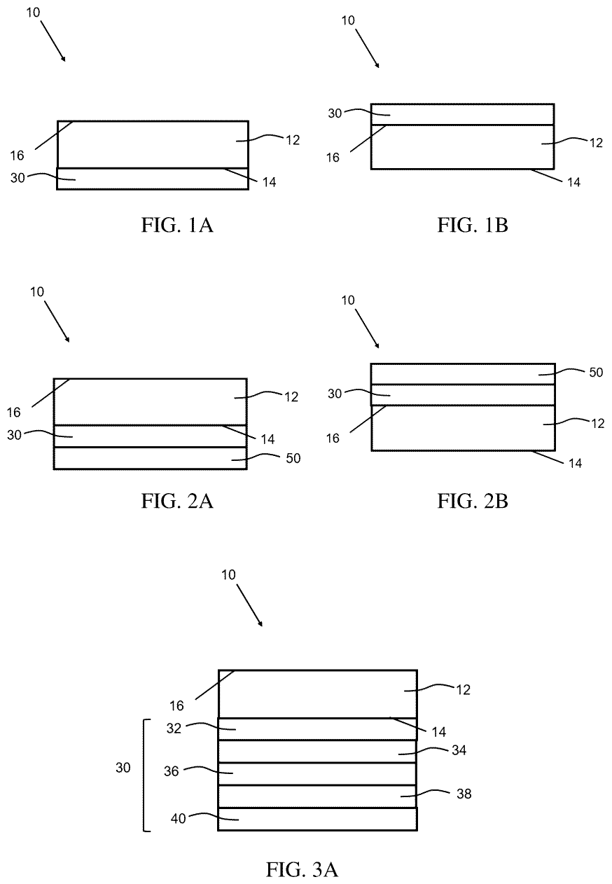

In some embodiments, the glass substrate 12 can be a monolithic glazing, as shown in FIGS. 1A-1B, 2A-2B, 3A-3B, 4A-4B, 5A-5B, 6A-6B, and 7A-7B. By “monolithic” is meant having a single structural support or structural member, e.g. having a single glass substrate.

A non-conductive solar control coating 30 comprising an alternating stack of high refractive index material layers and low refractive index material layers is positioned on the No. 1 surface 14 (FIG. 1A) or the No. 2 surface 16 (FIG. 1B) of the glass substrate 12. The non-conductive solar control coating 30 may further comprise at least one medium refractive index material layer.

The non-conductive solar control coating 30 may be the only coating on the No. 1 surface 14 of the glass substrate 12 or the No. 2 surface 16 of the glass substrate 12. Alternatively, when the non-conductive solar control coating 30 is on the No. 1 surface 14 of the glass substrate 12, there may be coating on the No. 2 surface 16 of the glass substrate 12. Alternatively, when the non-conductive solar control coating 30 is on the No. 2 surface 14 of the glass substrate 12, there may a coating on the No. 1 surface of the glass substrate.

The non-conductive solar control coating 30 is reflective to electromagnetic radiation having a wavelength in the infrared radiation region. Therefore, the non-conductive solar control coating 30 exhibits a low absorption of electromagnetic radiation in the infrared radiation region of the electromagnetic spectrum. For example, the non-conductive solar control coating 30 is reflective to infrared radiation having wavelengths in the range of from about 700 nanometers (nm) to greater than 1 millimeter (mm).

The non-conductive solar control coating 30 is reflective to electromagnetic radiation having a wavelength in the ultraviolet radiation region. Therefore, the non-conductive solar control coating 30 exhibits a low absorption of electromagnetic radiation in the ultraviolet radiation region of the electromagnetic spectrum. For example, the non-conductive solar control coating 30 is reflective to ultraviolet radiation having wavelengths in the range of from about 100 nm to about 400 nm.

As used herein, a “high refractive index material” is any material that has an index of refraction that is higher than that of the “medium refractive index material” or the “low refractive index material”. For example, a high refractive index material of the present invention may have a refractive index of greater than 2.1. A “medium refractive index material” is any material that has an index of refraction that is higher than that of the low refractive index material but lower than the index of refraction of the high refractive index material. For example, a medium refractive index material of the present invention may have a refractive index in the range of from 1.7 to 2.1. A “low refractive index material” is any material that has an index of refraction that is lower that the index of refraction of the medium refractive index material and the high refractive index material. For example, a low refractive index material of the present invention has an index of refraction that is less than 1.7.

Non-limiting examples of low refractive index materials that are suitable for the low refractive index material layers include, but are not limited to silica, alumina, silicon aluminum oxide (SiAlO), alloys thereof, or combinations thereof.

If the low refractive index material layer comprises silicon aluminum oxide, the layer may comprise from 5 weight percent (wt. %) to 20 wt. % aluminum and 95 wt. % to 80 wt. % silicon, such as 10 wt. % to 20 wt. % aluminum and 90 wt. % to 80 wt. % silicon, such as, 20 wt. % to 25 wt. % aluminum and 80 wt. % to 75 wt. % silicon. For example, the low refractive index material layer may comprise silicon and aluminum comprising 5 wt. % aluminum and 95 wt. % silicon.

Non-limiting examples of medium refractive index materials that are suitable for the medium refractive index material layers include, but are not limited to zinc stannate, tin oxide (SnO₂), zinc oxide, silicon nitride (SiN), or combinations thereof. For example, the medium refractive index material suitable for the medium refractive index material layers may be zinc stannate. By “zinc stannate” is meant a composition of ZnₓSn₁₋ₓO₂₋ₓ (Formula 1) where “x” varies in the range of greater than 0 to less than 1. For instance, “x” can be greater than 0 and can be any fraction or decimal between greater than 0 to less than 1. For example, where x=⅔, Formula 1 is Zn_{2/3}Sn_{1/3}O_{4/3}, which is more commonly described as “Zn₂SnO₄”. A zinc stannate-containing layer has one or more of the forms of Formula 1 in a predominant amount in the layer.

Non-limiting examples of high refractive index materials suitable for the high refractive index material layers include, but are not limited to titania, zirconia, silicon zirconium nitride, niobium oxide, bismuth oxide, tungsten oxide, or mixtures thereof. For example, the high refractive index material layer comprises titania.

The non-conductive solar control coating 30 may comprise no more than ten high refractive index material layers. The high refractive index material layers may each independently comprise a thickness in a range of from 10 nm to 235 nm, such as from 12 nm to 225 nm, or such as from 14 nm to 220 nm.

The non-conductive solar control coating 30 may comprise no more than ten low refractive index material layers. The low refractive index material layers may each independently comprise a thickness in a range of from 14 nm to 235 nm, such as from 16 nm to 225 nm, or such as from 18 nm to 220 nm.

The non-conductive solar control coating 30 may further comprise at least one medium refractive index material layer. For example, the non-conductive solar control coating 30 may comprise one medium refractive index material layer. For example, the non-conductive solar control coating 30 may comprise two medium refractive index material layers. When the non-conductive solar control coating 30 comprises at least one medium refractive index material layer, the at least one medium refractive index material layer comprises a total thickness in a range of from 8 nm to 20 nm, such as from 9 nm to 18 nm, or such as from 9.5 nm to 15 nm.

The non-conductive solar control coating 30 may comprise a total thickness in a range from about 1100 nm to about 2400 nm. For example, the non-conductive solar control coating 30 may comprise a total thickness in a range of from about 1125 nm to about 2200 nm, such as from about 1150 nm to about 2000 nm, such as from about 1100 nm to about 1900 nm, such as from about 1100 nm to about 1800 nm, such as from about 1100 nm to about 1700 nm, such as from about 1100 nm to about 1600 nm, such as from about 1125 nm to 1590 nm, or such as from about 1150 nm to 1585 nm.

A protective overcoat 50 may be positioned over at least a portion of the non-conductive solar control coating 30, as shown in FIGS. 2A and 2B. The protective overcoat 50, when present, is positioned over at least a portion of the outermost layer of the non-conductive solar control coating 30. The protective coating 50 assists in protecting the underlying plurality of dielectric layers of the non-conductive solar control coating 30 from mechanical and chemical attack. The protective overcoat 50 can be an oxygen barrier coating layer to prevent or reduce the passage of ambient oxygen into the underlying layers during subsequent processing, e.g., such as during heating or bending. The protective overcoat 50 comprises a protective layer, wherein the protective layer comprises a metal oxide and/or a metal nitride. For example, the protective layer may comprise silicon nitride, silicon aluminum nitride, silicon aluminum oxynitride, silicon aluminum oxide, titanium aluminum oxide, titania, alumina, silica, zirconia, or combinations thereof. When present, the protective overcoat may have a total thickness that is greater than 0 nm.

For example, the protective overcoat 50 may include a protective layer having one or more metal oxide materials, such as but not limited to oxides of aluminum, silicon, or mixtures thereof. For example, the protective overcoat 50 can include a single protective layer comprising in the range of 0 wt. % to 100 wt. % alumina and/or 100 wt. % to 0 wt. % silica, such as 1 wt. % to 99 wt. % alumina and 99 wt. % to 1 wt. % silica, such as 5 wt. % to 95 wt. % alumina and 95 wt. % to 5 wt. % silica, such as 10 wt. % to 90 wt. % alumina and 90 wt. % to 10 wt. % silica, such as 15 wt. % to 90 wt. % alumina and 85 wt. % to 10 wt. % silica, such as 50 wt. % to 75 wt. % alumina and 50 wt. % to 25 wt. % silica, such as 50 wt. %, to 70 wt. % alumina and 50 wt. % to 30 wt. % silica, such as 35 wt. % to 100 wt. % alumina and 65 wt. % to 0 wt. % silica, e.g., 70 wt. % to 90 wt. % alumina and 30 wt. % to 10 wt. % silica, e.g., 75 wt. % to 85 wt. % alumina and 25 wt. % to 15 wt. % of silica, e.g., 88 wt. % alumina and 12 wt. % silica, e.g., 65 wt. % to 75 wt. % alumina and 35 wt. % to 25 wt. % silica, e.g., 70 wt. % alumina and 30 wt. silica, e.g., 60 wt. % to less than 75 wt. % alumina and greater than 25 wt. % to 40 wt. % silica. In one particular non-limiting embodiment, the protective coating 50 comprises 40 wt. % to 15 wt. % alumina and 60 wt. % to 85 wt. % silica such as 85 wt. % silica and 15 wt. % alumina.

The protective overcoat 50 may be sputtered from two cathodes (e.g., one silicon and one aluminum) or from a single cathode containing both silicon and aluminum. This silicon aluminum oxide protective coating 50 can be written as SiₓAl₁₋ₓO_{1.5+x/2}, where x can vary from greater than 0 to less than 1.

The protective overcoat 50 can comprise a multi-layer structure, e.g., a first protective layer with at least one second protective layer formed over the first protective layer. For example, the first protective layer can comprise alumina or a mixture or alloy comprising alumina and silica. For example, the first layer can comprise a silica/alumina mixture having greater than 5 wt. % alumina, such as greater than 10 wt. % alumina, such as greater than 15 wt. % alumina, such as greater than 30 wt. % alumina, such as greater than 40 wt. % alumina, such as 50 wt. % to 70 wt. % alumina, such as in the range of 70 wt. % to 100 wt. % alumina and 30 wt. % to 0 wt. % silica, such as greater than 90 wt. % alumina, such as greater than 95 wt. % alumina. Alternatively, the first protective layer may comprise all or substantially all alumina. The second protective layer can comprise silica or a mixture or alloy comprising silica and alumina. For example, the second protective layer can comprise a silica/alumina mixture having greater than 40 wt. % silica, such as greater than 50 wt. % silica, such as greater than 60 wt. % silica, such as greater than 70 wt. % silica, such as greater than 80 wt. % silica, such as in the range of 80 wt. % to 90 wt. % silica and 10 wt. % to 20 wt. % alumina, e.g., 85 wt. % silica and 15 wt. % alumina.

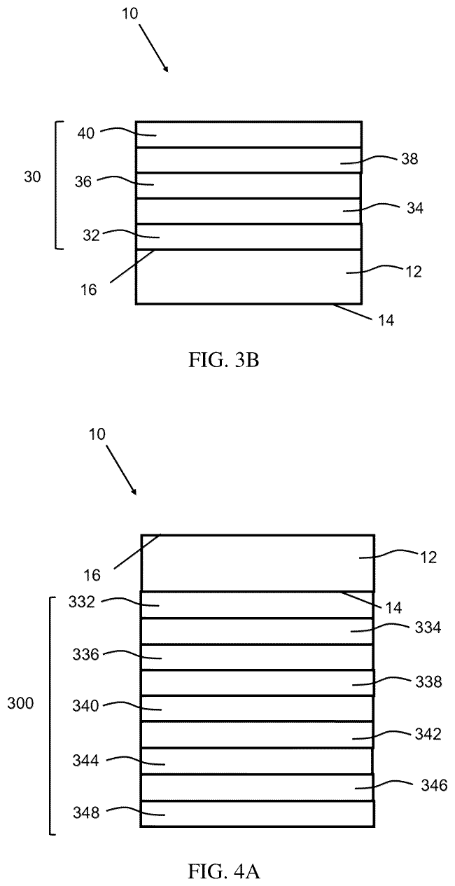

The non-conductive solar control coating 30 may comprise five layers of alternating high refractive index material layers and low refractive index materials layers, as shown in FIGS. 3A and 3B. The non-conductive solar control coating 30 may comprise: a first dielectric layer 32 having a first refractive index positioned over at least a portion of the No. 1 surface 14 (FIG. 3A) or the No. 2 surface 16 (FIG. 3B) of the glass substrate; a second dielectric layer 34 having a second refractive index positioned over at least a portion of the first dielectric layer 32; a third dielectric layer 36 having a third refractive index positioned over at least a portion of the second dielectric layer 34; a fourth dielectric layer 38 having a fourth refractive index positioned over at least a portion of the third dielectric layer 36; and a fifth dielectric layer 40 having a fifth refractive index positioned over at least a portion of the fourth dielectric layer 38.

The high refractive index material layers of the non-conductive solar control coating 30 include the first dielectric layer 32 comprising the first refractive index, the third dielectric layer 36 comprising a third refractive index, and the fifth dielectric layer 40 comprising the fifth refractive index. The low refractive index materials layers of the non-conductive solar control coating 30 include the second dielectric layer 34 comprising the second refractive index and the fourth dielectric layer 38 comprising the fourth refractive index.

The first refractive index of the first dielectric layer 32 of the non-conductive solar control coating 30 is higher than the second refractive index of the second dielectric layer 34. The third refractive index of the third dielectric layer 36 of the non-conductive solar control coating 30 is higher than the second refractive index of the second dielectric layer 34. The fifth refractive index of the fifth dielectric layer 40 of the non-solar control coating 30 is higher than the fourth refractive index of the fourth dielectric layer 38.

The first dielectric layer 32 of the non-conductive solar control coating 30 may comprise a first material and the second dielectric layer 34 of the non-conductive solar control coating 30 may comprise a second material. The second material of the second dielectric layer 34 is different from the first material of the first dielectric layer 32.

The first dielectric layer 32 and the third dielectric layer 36 of the non-conductive solar control coating 30 may comprise a first material. The second dielectric layer 34 of the non-conductive solar control coating 30 may comprise a second material.

As a non-limiting example, the non-conductive solar control coating 30 may comprise a first dielectric layer 32 comprising titania over at least a portion of the No. 1 surface 14 or the No. 2 surface 16 of the glass substrate 12, a second dielectric layer 34 comprising silicon aluminum oxide over at least a portion of the first dielectric layer 32, a third dielectric layer 36 comprising titania over at least a portion of the second dielectric layer 34, a fourth dielectric layer 38 comprising silicon aluminum oxide over at least a portion of the third dielectric layer 36, and a fifth dielectric layer 40 comprising titania over at least a portion of the fourth dielectric layer 38.

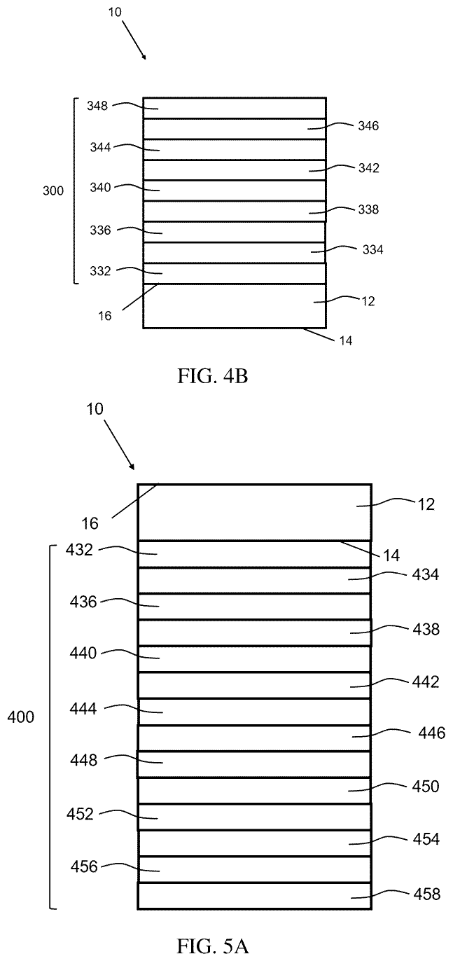

Also provided herein is an article 10 that includes a glass substrate 12 having a No. 1 surface 14 and a No. 2 surface 16 opposite the No. 1 surface 14 and a non-conductive solar control coating 300 on the No. 1 surface 14 or the No. 2 surface 16 of the glass substrate 12 comprising a plurality of dielectric layers, as provided in FIGS. 4A and 4B. The non-conductive solar control coating 300 comprises an alternating stack of high refractive index material layers and low refractive index material layers. The non-conductive solar control coating 300 includes: a first dielectric layer 332 having a high refractive index positioned over at least a portion of the No. 1 surface 14 (FIG. 4A) or the No. 2 surface 16 (FIG. 4B) of the glass substrate 12; second dielectric layer 334 having a low refractive index positioned over at least a portion of the first dielectric layer 332; a third dielectric layer 336 having a high refractive index positioned over at least a portion of the second dielectric layer 334; a fourth dielectric layer 338 having a low refractive index over at least a portion of the third dielectric layer 336; a fifth dielectric layer 340 having a high refractive index over at least a portion of the fourth dielectric layer 338; a sixth dielectric layer 342 having a low refractive index positioned over at least a portion of the fifth dielectric layer 340; a seventh dielectric layer 344 having a high refractive index positioned over at least a portion of the sixth dielectric layer 342; an eighth dielectric layer 346 having a low refractive index positioned over at least a portion of the seventh dielectric layer 344; and a ninth dielectric layer 348 having a high refractive index positioned over at least a portion of the eighth dielectric layer 346.

The high refractive index layers (i.e., the first dielectric layer 332, the third dielectric layer 336, the fifth dielectric layer 340, the seventh dielectric layer 344, and the ninth dielectric layer 348) of the non-conductive solar control coating 300 may comprise any of the high refractive index materials described herein. For example, the first dielectric layer 332, the third dielectric layer 336, the fifth dielectric layer 340, the seventh dielectric layer 344, and the ninth dielectric layer 348 may each independently comprise a high refractive index material selected from the group consisting of titania, zirconia, silicon zirconium nitride, niobium oxide, bismuth oxide, tungsten oxide, and mixtures thereof. For example, the first dielectric layer 332, the third dielectric layer 336, the fifth dielectric layer 340, the seventh dielectric layer 344, and the ninth dielectric layer 348 may each comprise titania.

The low refractive index layer (i.e., the second dielectric layer 334, the fourth dielectric layer 338, the sixth dielectric layer 342, and the eighth dielectric layer 346) of the non-conductive solar control coating 300 may comprise any of the low refractive index materials described herein. For example, the second dielectric layer 334, the fourth dielectric layer 338, the sixth dielectric layer 342, and the eighth dielectric layer 346 may each independently comprise a low refractive index material selected from the group consisting of silica, alumina, silicon aluminum oxide (SiAlO), alloys thereof, and combinations thereof. For example, the second dielectric layer 334, the fourth dielectric layer 338, the sixth dielectric layer 342, and the eighth dielectric layer 346 may each comprise silicon aluminum oxide.

The non-conductive solar control coating 300 may further comprise at least one dielectric layer having a medium refractive index. The at least one dielectric layer having a medium refractive index may include any of the medium refractive index materials as described herein. For example, the non-conductive solar control coating 300 may comprise at least one dielectric layer comprising zinc stannate. When the non-conductive solar control coating 300 comprises at least one medium refractive index material layer, the at least one medium refractive index material layer comprises a total thickness in the range of from 8 nm to 20 nm, such as from 9 nm to 18 nm, or such as from 9.5 nm to 15 nm.

For example, when present, the at least one medium refractive index material layer may be positioned between the No. 1 surface 14 or the No. 2 surface 16 of the glass substrate 12 and the first dielectric layer 332 having a high refractive index. For example, when present, the at least one medium refractive index material layer may be positioned between the first dielectric layer 332 and the second dielectric layer 334. For example, when present, the at least one medium refractive index material layer may be positioned between the eighth dielectric layer 346 and the ninth dielectric layer 348. For example, when present, the at least one medium refractive index material layer may be positioned over the ninth dielectric layer 348. For example, the non-conductive solar control coating 300 may comprise a first medium refractive index material layer positioned between the No. 1 surface 14 or the No. 2 surface 16 of the glass substrate 12 and the first dielectric layer 332 and a second medium refractive index material layer positioned between the eighth dielectric layer 346 and the ninth dielectric layer 348.

The non-conductive solar control coating 300 may comprise a total thickness in the range from about 1100 nm to about 1600 nm, such as from 1125 nm to 1300 nm, or such as from 1150nm to 1200 nm.

A protective overcoat 50 may be positioned over at least a portion of the non-conductive solar control coating 300 (not shown in FIGS. 4A and 4B). The protective overcoat 50, when present, is positioned over at least a portion of the ninth dielectric layer 348 of the non-conductive solar control coating 300. The protective coating 50 may be any of the protective coatings 50 described herein.

When the non-conductive solar control coating 300 comprises alternating high refractive index material layers and low refractive index materials layers, the non-conductive solar control coating 300 may comprise a first dielectric layer 332 comprising titania over at least a portion of the No. 1 surface 14 or the No. 2 surface 16 of the glass substrate 12, a second dielectric layer 334 comprising silicon aluminum oxide over at least a portion of the first dielectric layer 332, a third dielectric layer 336 comprising titania over at least a portion of the second dielectric layer 334, a fourth dielectric layer 338 comprising silicon aluminum oxide over at least a portion of the third dielectric layer 336, a fifth dielectric layer 340 comprising titania over at least a portion of the fourth dielectric layer 338, a sixth dielectric layer 342 comprising silicon aluminum oxide over at least a portion of the fifth dielectric layer 340, a seventh dielectric layer 344 comprising titania over at least a portion of the sixth dielectric layer 442, an eighth dielectric layer 346 comprising silicon aluminum oxide over at least a portion of the seventh dielectric layer 344, and a ninth dielectric layer 348 comprising titania over at least a portion of the eighth dielectric layer 346.

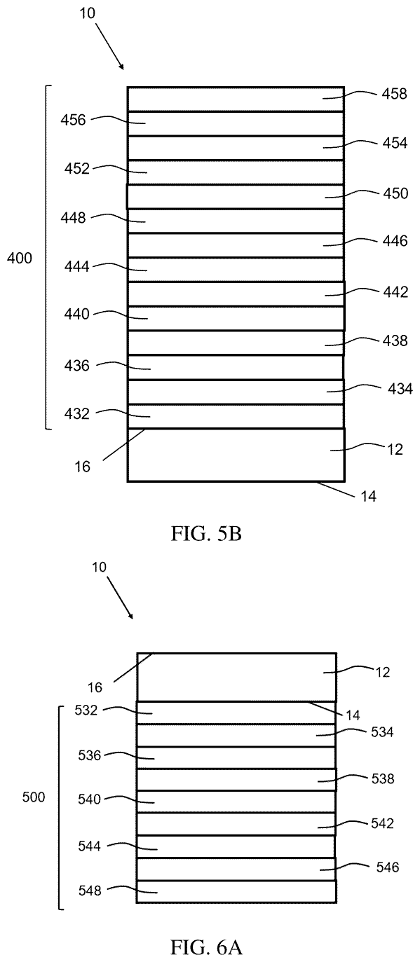

Also provided herein is an article that includes a glass substrate 12 having a No. 1 surface 14 and a No. 2 surface 16 opposite the No. 1 surface 14 and a non-conductive solar control coating 400 on the No. 1 surface 14 or the No. 2 surface 16 of the glass substrate 12 comprising a plurality of dielectric layers, as shown in FIGS. 5A and 5B. The non-conductive solar control coating 400 comprises an alternating stack of high refractive index material layers and low refractive index material layers. The non-conductive solar control coating 400 includes: a first dielectric layer 432 having a medium refractive index positioned over at least a portion of the No. 1 surface 14 (FIG. 5A) or the No. 2 surface 16 (FIG. 5B) of the glass substrate 12; second dielectric layer 434 having a high refractive index positioned over at least a portion of the first dielectric layer 432; a third dielectric layer 436 having a low refractive index positioned over at least a portion of the second dielectric layer 434; a fourth dielectric layer 438 having a high refractive index over at least a portion of the third dielectric layer 436; a fifth dielectric layer 440 having a low refractive index over at least a portion of the fourth dielectric layer 438; a sixth dielectric layer 442 having a high refractive index positioned over at least a portion of the fifth dielectric layer 440; a seventh dielectric layer 444 having a low refractive index positioned over at least a portion of the sixth dielectric layer 442; an eighth dielectric layer 446 having a high refractive index positioned over at least a portion of the seventh dielectric layer 444; a ninth dielectric layer 448 having a low refractive index positioned over at least a portion of the eighth dielectric layer 446; a tenth dielectric layer 450 having a high refractive index over at least a portion of the ninth dielectric layer 448; an eleventh dielectric layer 452 having a low refractive index over at least a portion of the tenth dielectric layer 450; a twelfth dielectric layer 454 having a high refractive index positioned over at least a portion of the eleventh dielectric layer 452; a thirteenth dielectric layer 456 having a medium refractive index positioned over at least a portion of the twelfth dielectric layer 454; and a fourteenth dielectric layer 458 having a high refractive index positioned over at least a portion of the thirteenth dielectric layer 456.

The medium refractive index layers (i.e., the first dielectric layer 432 and the thirteenth dielectric layer 456) of the non-conductive solar control coating 400 may include any of the medium refractive index materials as described herein. For example, the first dielectric layer 432 may comprise zinc stannate. The first dielectric layer 432 may comprise a total thickness in the range of from 8 nm to 20 nm, such as from 9 nm to 18 nm, or such as from 9.5 nm to 15 nm. For example, the thirteenth dielectric layer 456 may comprise zinc stannate. The thirteenth dielectric layer 432 may comprise a total thickness in the range of from 8 nm to 20 nm, such as from 9 nm to 18 nm, or such as from 9.5 nm to 15 nm.

The high refractive index layers (i.e., the second dielectric layer 432, the fourth dielectric layer 438, the sixth dielectric layer 442, the eighth dielectric layer 446, the tenth dielectric layer 450, the twelfth dielectric layer 454, and the fourteenth dielectric layer 458) of the non-conductive solar control coating 400 may comprise any of the high refractive index materials described herein, such as a high refractive material index material selected from the group consisting of titania, zirconia, silicon zirconium nitride, niobium oxide, bismuth oxide, tungsten oxide, and mixtures thereof. For example, the second dielectric layer 432, the fourth dielectric layer 438, the sixth dielectric layer 442, the eighth dielectric layer 446, the tenth dielectric layer 450, the twelfth dielectric layer 454, and the fourteenth dielectric layer 458 may each comprise titania.

The low refractive index layers (i.e., the third dielectric layer 436, the fifth dielectric layer 440, the seventh dielectric layer 444, the ninth dielectric layer 448, and the eleventh dielectric layer 452) of the non-conductive solar control coating 400 may comprise any of the low refractive index materials described herein. For example, the third dielectric layer 436, the fifth dielectric layer 440, the seventh dielectric layer 444, the ninth dielectric layer 448, and the eleventh dielectric layer 452 may each independently comprise a low refractive index material selected from the group consisting of silica, alumina, silicon aluminum oxide (SiAlO), alloys thereof, and combinations thereof. For example, the third dielectric layer 436, the fifth dielectric layer 440, the seventh dielectric layer 444, the ninth dielectric layer 448, and the eleventh dielectric layer 452 may each comprise silicon aluminum oxide.

The non-conductive solar control coating 400 may comprise a total thickness in the range from about 1100 nm to about 1600 nm, such as from 1300 nm to 1600 nm, or such as from 1500 nm to 1590 nm.

A protective overcoat 50 may be positioned over at least a portion of the non-conductive solar control coating 400 (not shown in FIGS. 5A and 5B). The protective overcoat 50, when present, is positioned over at least a portion of the fourteenth dielectric layer 458 of the non-conductive solar control coating 400. The protective coating 50 may be any of the protective coatings 50 described herein.

When the non-conductive solar control coating 400 comprises alternating high refractive index material layers and low refractive index materials layers, the non-conductive solar control coating 400 may comprise a first dielectric layer 432 comprising zinc stannate over at least a portion of the No. 1 surface 14 or the No. 2 surface 16 of the glass substrate 12, a second dielectric layer 434 comprising titania over at least a portion of the first dielectric layer 432, a third dielectric layer 436 comprising silicon aluminum oxide over at least a portion of the second dielectric layer 434, a fourth dielectric layer 438 comprising titania over at least a portion of the third dielectric layer 436, a fifth dielectric layer 440 comprising silicon aluminum oxide over at least a portion of the fourth dielectric layer 438, a sixth dielectric layer 442 comprising silicon aluminum oxide over at least a portion of the fifth dielectric layer 440, a seventh dielectric layer 444 comprising silicon aluminum oxide over at least a portion of the sixth dielectric layer 442, an eighth dielectric layer 446 comprising titania over at least a portion of the seventh dielectric layer 444, a ninth dielectric layer 448 comprising silicon aluminum oxide over at least a portion of the eighth dielectric layer 446, a tenth dielectric layer 450 comprising titania over at least a portion of the ninth dielectric layer 448, an eleventh dielectric layer 452 comprising silicon aluminum oxide over at least a portion of the tenth dielectric layer 450, a twelfth dielectric layer 454 comprising titania over at least a portion of the eleventh dielectric layer 452, a thirteenth dielectric layer 456 comprising zinc stannate over at least a portion of the twelfth dielectric layer 454, and a fourteenth dielectric layer 458 comprising titania over at least a portion of the thirteenth dielectric layer 456.

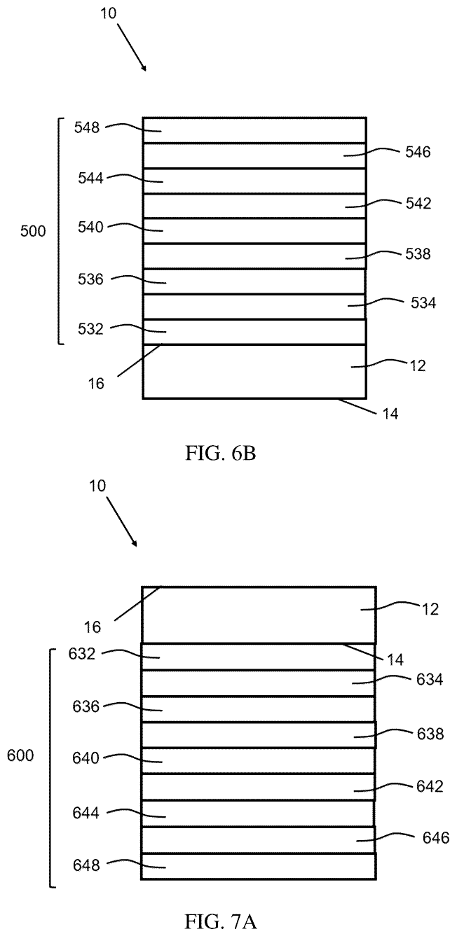

Also provided herein is an article 10 comprising a glass substrate 12 having a No. 1 surface 14 and a No. 2 surface 16 opposite the No. 1 surface 14 and a non-conductive solar control coating 500 on the No. 1 surface 14 or the No. 2 surface 16 of the glass substrate 12 comprising a plurality of dielectric layers, as shown in FIGS. 6A and 6B. The non-conductive solar control coating 500 comprises an alternating stack of low refractive index material layers and medium refractive index material layers. The non-conductive solar control coating 500 comprises: a first dielectric layer 532 having a low refractive index positioned over at least a portion of the No. 1 surface 14 (FIG. 6A) or the No. 2 surface 16 (FIG. 6B) of the glass substrate 12; a second dielectric layer 534 having a medium refractive index positioned over at least a portion of the first dielectric layer 532; a third dielectric layer 536 having a low refractive index positioned over at least a portion of the second dielectric layer 534; a fourth dielectric layer 538 having a medium refractive index positioned over at least a portion of the third dielectric layer 536; a fifth dielectric layer 540 having a low refractive index positioned over at least a portion of the fourth dielectric layer 538; a sixth dielectric layer 542 having a medium refractive index positioned over at least a portion of the fifth dielectric layer 540; a seventh dielectric layer 544 having a low refractive index positioned over at least a portion of the sixth dielectric layer 542; an eighth dielectric layer 546 having a medium refractive index positioned over at least a portion of the seventh dielectric layer; and a ninth dielectric layer 548 having a low refractive index positioned over at least a portion of the eighth dielectric layer 546.

The medium refractive index layers (i.e., the second dielectric layer 534, the fourth dielectric layer 538, the sixth dielectric layer 542, and the eighth dielectric layer 546) of the non-conductive solar control coating 500 may comprise any of the medium refractive index materials described herein. For example, the second dielectric layer 534, the fourth dielectric layer 538, sixth dielectric layer 542, and the eighth dielectric layer 546 may each comprise zinc stannate. The second dielectric layer 534 may comprise a total thickness in the range of from 8 nm to 20 nm, such as from 9 nm to 18 nm, or such as from 9.5 nm to 15 nm. The fourth dielectric layer 538 may comprise a total thickness in the range of from 8 nm to 20 nm, such as from 9 nm to 18 nm, or such as from 9.5 nm to 15 nm. The sixth dielectric layer 542 may comprise a total thickness in the range of from 8 nm to 20 nm, such as from 9 nm to 18 nm, or such as from 9.5 nm to 15 nm. The eighth dielectric layer 546 may comprise a total thickness in the range of from 8 nm to 20 nm, such as from 9 nm to 18 nm, or such as from 9.5 nm to 15 nm.

The low refractive index layers (i.e., the first dielectric layer 532, the third dielectric layer 536, the fifth dielectric layer 540, the seventh dielectric layer 544, and the ninth dielectric layer 548) of the non-conductive solar control coating 500 may comprise any of the low refractive index materials described herein. For example, the first dielectric layer 532, the third dielectric layer 536, the fifth dielectric layer 540, the seventh dielectric layer 544, and the ninth dielectric layer 548 may each independently comprise a low refractive index material selected from the group consisting of silica, alumina, silicon aluminum oxide (SiAlO), alloys thereof, and combinations thereof.

The non-conductive solar control coating 500 may comprise a total thickness in the range from about 1100 nm to about 1600 nm, such as from 1125 nm to 1300 nm, or such as from 1150nm to 1200 nm.

A protective overcoat 50 may be positioned over at least a portion of the non-conductive solar control coating 500 (not shown in FIGS. 6A and 6B). The protective overcoat 50, when present, is positioned over at least a portion of the ninth dielectric layer 548 of the non-conductive solar control coating 500. The protective coating 50 may be any of the protective coatings 50 described herein.

For example, when the non-conductive solar control coating 500 comprises alternating low refractive index material layers and medium refractive index materials layers, the non-conductive solar control coating 500 may comprise a first dielectric layer 532 comprising silicon aluminum oxide over at least a portion of the No. 1 surface 14 or the No. 2 surface 16 of the glass substrate 12, a second dielectric layer 534 comprising zinc stannate over at least a portion of the first dielectric layer 532, a third dielectric layer 536 comprising silicon aluminum oxide over at least a portion of the second dielectric layer 534, a fourth dielectric layer 538 comprising zinc stannate over at least a portion of the third dielectric layer 536, a fifth dielectric layer 540 comprising silicon aluminum oxide over at least a portion of the fourth dielectric layer 538, a sixth dielectric layer 542 comprising zinc stannate over at least a portion of the fifth dielectric layer 540, a seventh dielectric layer 544 comprising silicon aluminum oxide over at least a portion of the sixth dielectric layer 542, an eighth dielectric layer 546 comprising zinc stannate over at least a portion of the seventh dielectric layer 544, and a ninth dielectric layer 548 comprising silicon aluminum oxide over at least a portion of the eighth dielectric layer 546.

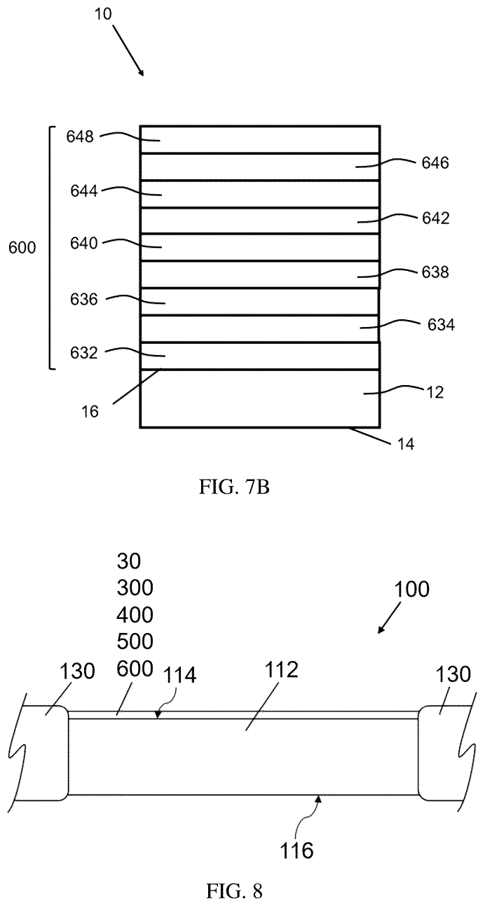

Also provided herein is an article 10 comprising a glass substrate 12 having a No. 1 surface 14 and a No. 2 surface 16 opposite the No. 1 surface 14 and a non-conductive solar control coating 600 on the No. 1 surface 14 or the No. 2 surface 16 of the glass substrate 12 comprising a plurality of dielectric layers, as shown in FIGS. 7A and 7B. The non-conductive solar control coating 600 comprises an alternating stack of medium refractive index material layers and high refractive index material layers. The non-conductive solar control coating 600 comprises: a first dielectric layer 632 having a medium refractive index positioned over at least a portion of the No. 1 surface 14 (FIG. 7A) or the No. 2 surface (FIG. 7B) of the glass substrate 12; a second dielectric layer 634 having a high refractive index positioned over at least a portion of the first dielectric layer 632; a third dielectric layer 636 having a medium refractive index positioned over at least a portion the second dielectric layer 634; a fourth dielectric layer 638 having a high refractive index positioned over at least a portion of the third dielectric layer 636; a fifth dielectric layer 640 having a medium refractive index positioned over at least a portion of the fourth dielectric layer 638; a sixth dielectric layer 642 having a high refractive index positioned over at least a portion of the fifth dielectric layer 640; a seventh dielectric layer 644 having a medium refractive index positioned over at least a portion of the sixth dielectric layer 642; an eighth dielectric layer 646 having a high refractive index positioned over at least a portion of the seventh dielectric layer 644; and a ninth dielectric layer 648 having a medium refractive index positioned over at least a portion of the eighth dielectric layer 646.

The medium refractive index layers (i.e., the first dielectric layer 632, the third dielectric layer 636, the fifth dielectric layer 640, the seventh dielectric layer 644, and the ninth dielectric layer 648) of the non-conductive solar control coating 600 may comprise any of the medium refractive index materials described herein. For example, the first dielectric layer 632, the third dielectric layer 636, the fifth dielectric layer 640, the seventh dielectric layer 644, and the ninth dielectric layer 648 may each comprise zinc stannate. The first dielectric layer 632 may comprise a total thickness in the range of from 8 nm to 20 nm, such as from 9 nm to 18 nm, or such as from 9.5 nm to 15 nm. The third dielectric layer 636 may comprise a total thickness in the range of from 8 nm to 20 nm, such as from 9 nm to 18 nm, or such as from 9.5 nm to 15 nm. The fifth dielectric layer 640 may comprise a total thickness in the range of from 8 nm to 20 nm, such as from 9 nm to 18 nm, or such as from 9.5 nm to 15 nm. The seventh dielectric layer 644 may comprise a total thickness in the range of from 8 nm to 20 nm, such as from 9 nm to 18 nm, or such as from 9.5 nm to 15 nm. The ninth dielectric layer 648 may comprise a total thickness in the range of from 8 nm to 20 nm, such as from 9 nm to 18 nm, or such as from 9.5 nm to 15 nm.

The high refractive index layers (i.e., the second dielectric layer 632, the fourth dielectric layer 638, the sixth dielectric layer 642, and the eighth dielectric layer 646) of the non-conductive solar control coating 400 may comprise any of the high refractive index materials described herein. For example, the second dielectric layer 632, the fourth dielectric layer 638, the sixth dielectric layer 642, and the eighth dielectric layer 646 may each independently comprise a high refractive material index material selected from the group consisting of titania, zirconia, silicon zirconium nitride, niobium oxide, bismuth oxide, tungsten oxide, and mixtures thereof. For example, the second dielectric layer 632, the fourth dielectric layer 638, the sixth dielectric layer 642, and the eighth dielectric layer 646 may comprise titania.

The non-conductive solar control coating 600 may comprise a total thickness in the range from about 1100 nm to about 1600 nm, such as from 1125 nm to 1300 nm, or such as from 1150 nm to 1200 nm.

A protective overcoat 50 may be positioned over at least a portion of the non-conductive solar control coating 600 (not shown in FIGS. 7A and 7B). The protective overcoat 50, when present, is positioned over at least a portion of the ninth dielectric layer 648 of the non-conductive solar control coating 600. The protective coating 50 may be any of the protective coatings 50 described herein.

When the non-conductive solar control coating 600 comprises alternating medium refractive index material layers and high refractive index materials layers, the non-conductive solar control coating 600 may comprise a first dielectric layer 632 comprising zinc stannate over at least a portion of the No. 1 surface 14 or the No. 2 surface 16 of the glass substrate 12, a second dielectric layer 634 comprising titania over at least a portion of the first dielectric layer 632, a third dielectric layer 636 comprising zinc stannate over at least a portion of the second dielectric layer 634, a fourth dielectric layer 638 comprising titania over at least a portion of the third dielectric layer 636, a fifth dielectric layer 640 comprising zinc stannate over at least a portion of the fourth dielectric layer 638, a sixth dielectric layer 642 comprising titania over at least a portion of the fifth dielectric layer 640, a seventh dielectric layer 644 comprising zinc stannate over at least a portion of the sixth dielectric layer 642, an eighth dielectric layer 646 comprising titania over at least a portion of the seventh dielectric layer 644, and a ninth dielectric layer 648 comprising zinc stannate over at least a portion of the eighth dielectric layer 646.

The coated articles described herein can be used in a vehicle transparency 100, such as a windshield, a sidelite, a backlite, or sunroof. A non-limiting vehicle transparency 100 incorporating features of the invention is provided in FIG. 8. For clarity, seals, connectors, and opening mechanisms are not shown, nor is the complete vehicle. The transparency 100 includes a first ply 112 with a first major surface 114 (No. 1 surface) and an opposed second major surface 116 (No. 2 surface) mounted in the body of a vehicle 130 (shown in part). The ply 112 may be any of the substrates described herein. In the illustrated non-limiting embodiment, the first major surface 114 faces the vehicle's exterior, and thus is an outer major surface, and the second major surface 116 faces the interior of the vehicle. Non-limiting examples of a vehicle body include: an automobile roof in the case of a sunroof, an automobile door or frame in the case of an automobile window, or a fuselage of an airplane. The transparency 100 may be affixed to a mechanism by which the transparency, such as, a car window or sunroof, can be opened and closes, as is broadly known in the vehicular arts.

A non-conductive solar control coating 30, 300, 400, 500, 600 is shown as formed over the No. 1 surface 114, but it may be formed over at least a portion of the No. 2 surface 116. The coating 30, 300, 400, 500, 600 may comprise, consist essentially of, or consist of any of the coatings described herein. When the non-conductive solar control coating 30, 300, 400, 500, 600 is on the No. 1 surface 114 of the first ply 112, the non-conductive solar control coating 30, 300, 400, 500, 600 may be the only coating on the first ply 112. When the non-conductive solar control coating 30, 300, 400, 500, 600 is on the No. 2 surface 116 of the first ply 112, the non-conductive solar control coating 30, 300, 400, 500, 600 may be the only coating on the first ply 112. Alternatively, when the non-conductive solar control coating 30, 300, 400, 500, 600 is on the No. 1 surface 114 of the first ply 112, there may be a coating on the No. 2 surface 116 of the first ply 112. Alternatively, when the non-conductive solar control coating 30, 300, 400, 500, 600 is on the No. 2 surface 120 of the first ply 112, there may a coating on the No. 1 surface 114 of the first ply 112.

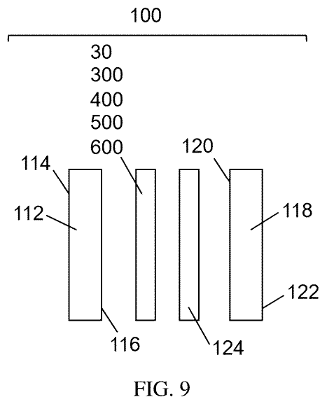

The vehicle transparency 100 may further comprise a first ply 112 with a first major surface facing the vehicle exterior, i.e., an outer major surface 114 (No. 1 surface) and an opposed second or inner major surface 116 (No. 2 surface) and a second ply 118 having an outer (first) major surface 122 (No. 4 surface) and an inner (second) major surface 120 (No. 3 surface) (FIG. 9). This numbering of the ply surfaces is in keeping with conventional practice in the automotive art. The first and second plies 112, 118 can be any of the substrates described herein. The first and second plies 112, 118 may be of the same or different materials. The first and second plies 112, 118 may be bonded together in any suitable manner, such as by a conventional interlayer 124. Although not required, a conventional edge sealant can be applied to the perimeter of the laminated transparency 100 during and/or after lamination in any desired manner. A decorative band, e.g., an opaque, translucent or colored shade band, such as a ceramic band, can be provided on a surface of at least one of the plies 112, 118, for example around the perimeter of the inner major surface 116 of the first ply 112 (not show in FIG. 9).

A non-conductive solar control coating 30, 300, 400, 500, 600 is shown as formed over the No. 2 surface 116 in FIG. 9, but it may be formed over at least a portion of the No. 3 surface 120 of the second ply 218. The coating 30, 300, 400, 500, 600 may comprise, consist essentially of, or consist of any of the coatings described herein. When the non-conductive solar control coating 30, 300, 400, 500, 600 is on the No. 2 surface 116 of the first ply 112, the non-conductive solar control coating 30, 300, 400, 500, 600 may be the only coating on the first ply 112. When the non-conductive solar control coating 30, 300, 400, 500, 600 is on the No. 3 surface 120 of the second ply 118, the non-conductive solar control coating 30, 300, 400, 500, 600 may be the only coating on the second ply 118. Alternatively, when the non-conductive solar control coating 30, 300, 400, 500, 600 is on the No. 2 surface 116 of the first ply 112, there may be a coating on the No. 1 surface 114 of the first ply 112. Alternatively, when the non-conductive solar control coating 30, 300, 400, 500, 600 is on the No. 3 surface 120 of the second ply 118, there may a coating on the No. 4 surface 122 of the second ply 118.

The interlayer 124 can be of any desired material and can include one or more layers or plies. The interlayer 124 can be a polymeric or plastic material, such as, for example, polyvinylbutyral, plasticized polyvinyl chloride, or multi-layered thermoplastic materials including polyethyleneterephthalate, etc. Suitable interlayer materials are disclosed, for example but not to be considered as limiting, in U.S. Pat. Nos. 4,287,107 and 3,762,988. The interlayer 124 secures the first and second plies 112, 118 together, provides energy absorption, reduces noise, and increases the strength of the laminated structure. The interlayer 124 can also be a sound absorbing or attenuating material as described, for example, in U.S. Pat. No. 5,796,055.

The invention is further described in the following numbered clauses:

Clause 1. An article comprising: a glass substrate having a No. 1 surface and a No. 2 surface opposite the No. 1 surface; and a non-conductive solar control coating on the No. 1 surface or the No. 2 surface comprising a plurality of dielectric layers, wherein the non-conductive solar control coating comprises an alternating stack of high refractive index material layers and low refractive index material layers.

Clause 2: The article of clause 1, wherein the low refractive index material layers have a refractive index of less than 1.7.

Clause 3: The article of clause 1 or 2, wherein there are no more than ten high refractive index material layers in the non-conductive solar control coating.

Clause 4: The article of clause 1 or 2, wherein there are no more than ten low refractive index material layers in the non-conductive solar control coating.

Clause 5: The article of any one of clauses 1 to 4, wherein the non-conductive solar control coating further comprises at least one medium refractive index material.

Clause 6: The article of claim 5, wherein the at least one medium refractive index material comprises zinc stannate.

Clause 7: The article of clause 5 or 6, wherein the at least one medium refractive index material has a thickness of about 8 nanometers (nm) to about 20 nm, such as from 9 nm to 18 nm, or such as from 9.5 nm to 15 nm.

Clause 8: The article of any one of clauses 1 to 7, wherein the high refractive index material layers each separately comprises a high refractive index material selected from the group consisting of titania, zirconia, silicon zirconium nitride, niobium oxide, bismuth oxide, tungsten oxide, and mixtures thereof.

Clause 9: The article of any one of clauses 1 to 8, wherein the low refractive index material layers each separately comprises a low refractive index material selected from the group consisting of silica, alumina, silicon aluminum oxide (SiAlO), alloys thereof, and combinations thereof.

Clause 10: The article of any one of clauses 1 to 9, wherein the low refractive index material layers each comprise SiAlO.

Clause 11: The article of any one of clauses 1 to 10, wherein the non-conductive solar control coating is reflective to electromagnetic radiation having a wavelength in the infrared radiation region.

Clause 12. The article of any one of clauses 1 to 11, wherein the non-conductive solar control coating is reflective to electromagnetic radiation having a wavelength in the ultraviolet radiation region.

Clause 13. The article of any one of clauses 1 to 12, wherein the article exhibits a luminous transmittance using standard illuminate A (LTA) of at least 70%.

Clause 14: The article of any one of clauses 1 to 13, wherein the high refractive index material layers comprise: a first dielectric layer having a first refractive index; a third dielectric layer having a third refractive index; and a fifth dielectric layer having a fifth refractive index, and wherein the low refractive index material layers comprise: a second dielectric layer having a second refractive index positioned over at least a portion of the first dielectric layer; and a fourth dielectric layer having a fourth refractive index positioned over the third dielectric layer.

Clause 15: The article of clause 14, wherein the first refractive index is higher than the second refractive index, and wherein the third refractive index is higher than the second refractive index.

Clause 16: The article of clause 14 or 15, wherein: the first refractive index is higher than the second refractive index; the third refractive index is higher than the second refractive index; and the fifth refractive index is higher than the fourth refractive index.

Clause 17: The article of any one of clauses 14 to 16, wherein the first dielectric layer comprises a first material and the second dielectric layer comprises a second material that is different than the first material.

Clause 18: The article of any one of clauses 14 to 16, wherein: the first dielectric layer and the third dielectric layer comprise a first material; and the second dielectric material comprises a second material.

Clause 19: The article of any one of clauses 1 to 18, further comprising a protective overcoat over at least a portion of the non-conductive solar control coating.

Clause 20: The article of clause 19, wherein the protective overcoat comprises SiAlO.

Clause 21: The article of any one of clauses 1 to 20, wherein the glass substrate is a soda-lime glass.

Clause 22: The article of any one of clauses 1 to 21, further comprising a second glass substrate opposite the first glass substrate having a No. 3 surface and a No. 4 surface opposite the No. 3 surface.

Clause 23: The article of any one of clauses 1 to 22, wherein the article is an automotive component.

Clause 24. The article of clause 23, wherein the automotive component is a windshield, a sidelite, a backlite, or sunroof.

Clause 25: The article of any one of clauses 1 to 24, wherein the non-conductive solar control coating has a total thickness of about 1100 nm to about 2400 nm, such as about 1125 nm to about 2200 nm, such as about 1150 nm to about 2000 nm, such as about 1100 nm to about 1900 nm, such as about 1100 nm to about 1800 nm, such as about 1100 nm to about 1700 nm, such as about 1100 nm to about 1600 nm, such as about 1125 nm to 1590 nm, or such as about 1150 nm to 1585 nm.

Clause 26: An article comprising: a glass substrate having a No. 1 surface and a No. 2 surface opposite the No. 1 surface; and a non-conductive solar control coating on the No. 1 surface or the No. 2 surface comprising a plurality of dielectric layers, wherein the coating comprises an alternating stack of high refractive index material layers and low refractive index material layers comprising: a first dielectric layer having a high refractive index; a second dielectric layer over the first dielectric layer having a low refractive index; a third dielectric layer over the second dielectric layer having a high refractive index; a fourth dielectric layer over the third dielectric layer having a low refractive index; a fifth dielectric layer over the fourth dielectric layer having a high refractive index; a sixth dielectric layer over the fifth dielectric layer having a low refractive index; a seventh dielectric layer over the sixth dielectric layer having a high refractive index; an eighth dielectric layer over the seventh dielectric layer having a low refractive index; and a ninth dielectric layer over the eighth dielectric layer having a high refractive index.

Clause 27: The article of clause 26, wherein the high refractive index material layers each separately comprise a high refractive index material selected from the group consisting of titania, zirconia, silicon zirconium nitride, niobium oxide, bismuth oxide, tungsten oxide, and mixtures thereof.

Clause 28: The article of clause 26 or 27, wherein the low refractive index material layers each separately comprises a low refractive index material selected from the group consisting of silica, alumina, silicon aluminum oxide (SiAlO), alloys thereof, and combinations thereof.

Clause 29: The article of any one of clauses 26 to 28, wherein the low refractive index material layers each comprise SiAlO.

Clause 30: The article of clause 26, wherein the non-conductive solar control coating has a total thickness of about 1100 nm to about 1600 nm, such as from 1125 nm to 1300 nm, or such as from 1150 nm to 1200 nm.

Clause 31: The article of any one of clauses 26 to 30, further comprising at least one dielectric layer having a medium refractive index.

Clause 32: The article of clause 31, wherein the at least one dielectric layer having a medium refractive index comprises zinc stannate.

Clause 33: The article of any one of clauses 26 to 32, wherein the non-conductive solar control coating is reflective to electromagnetic radiation having a wavelength in the infrared radiation region.

Clause 34: The article of any one of clauses 26 to 33, wherein the non-conductive solar control coating is reflective to electromagnetic radiation having a wavelength in the ultraviolet radiation region.

Clause 35: The article of any one of clauses 26 to 34, wherein the article exhibits a luminous transmittance using standard illuminate A (LTA) of at least 70%.

Clause 36: The article of any one of clauses 26 to 35, further comprising a protective overcoat over at least a portion of the non-conductive solar control coating.

Clause 37: The article of clause 36, wherein the protective overcoat comprises SiAIO.

Clause 38: The article of any one of clauses 26 to 37, wherein the glass substrate is a soda-lime glass.

Clause 39: The article of any one of clauses 26 to 38, further comprising a second glass substrate opposite the first glass substrate having a No. 3 surface and a No. 4 surface opposite the No. 3 surface.

Clause 40: The article of any one of clauses 26 to 39, wherein the article is an automotive component.

Clause 41. The article of clause 40, wherein the automotive component is a windshield, a sidelite, a backlite, or sunroof.

Clause 42: An article comprising: a glass substrate having a No. 1 surface and a No. 2 surface opposite the No. 1 surface; and a non-conductive solar control coating on the No. 1 surface or the No. 2 surface comprising a plurality of dielectric layers, wherein the coating comprises an alternating stack of high refractive index material layers and low refractive index material layers comprising: a first dielectric layer having a medium refractive index; a second dielectric layer over the first dielectric layer having a high refractive index; a third dielectric layer over the second dielectric layer having a low refractive index; a fourth dielectric layer over the third dielectric layer having a high refractive index; a fifth dielectric layer over the fourth dielectric layer having a low refractive index; a sixth dielectric layer over the fifth dielectric layer having a high refractive index; a seventh dielectric layer over the sixth dielectric layer having a low refractive index; an eighth dielectric layer over the seventh dielectric layer having a high refractive index; a ninth dielectric layer over the eighth dielectric layer having a low refractive index; a tenth dielectric layer over the ninth dielectric layer having a high refractive index; an eleventh dielectric layer over the tenth dielectric layer having a low refractive index; a twelfth dielectric layer over the eleventh dielectric layer having a high refractive index; a thirteenth dielectric layer over the twelfth dielectric layer having a medium refractive index; and a fourteenth dielectric layer over the thirteenth dielectric layer having a high refractive index.

Clause 43: The article of clause 42, wherein the first dielectric layer having a medium refractive index has a thickness of about 8 nanometers (nm) to about 20 nm, such as from 9 nm to 18 nm, or such as from 9.5 nm to 15 nm.

Clause 44: The article of clause 42 or 43, wherein the thirteenth dielectric layer having a medium refractive index has a thickness of about 8 nanometers (nm) to about 20 nm, such as from 9 nm to 18 nm, or such as from 9.5 nm to 15 nm.

Clause 45: The article of any one of clauses 42 to 44, wherein the first dielectric layer and the thirteenth dielectric layer comprise zinc stannate.

Clause 46: The article of any one of clauses 42 or 45, wherein the non-conductive solar control coating has a total thickness of about 1100 nm to about 1600 nm, such as from 1300 nm to 1600 nm, or such as from 1500 nm to 1590 nm.

Clause 47: The article of any one of clauses 42 to 46, wherein the high refractive index material layers each separately comprise a high refractive index material selected from the group consisting of titania, zirconia, silicon zirconium nitride, niobium oxide, bismuth oxide, tungsten oxide and mixtures thereof.

Clause 48: The article of any one of clauses 42 to 47, wherein the low refractive index material layers each separately comprises a low refractive index material selected from the group consisting of silica, alumina, silicon aluminum oxide (SiAlO), alloys thereof, and combinations thereof.

Clause 49: The article of any one of clauses 42 to 48, wherein the low refractive index material layers each comprise SiAlO.

Clause 50: The article of any one of clauses 42 to 49, wherein the non-conductive solar control coating is reflective to electromagnetic radiation having a wavelength in the infrared radiation region.

Clause 51. The article of any one of clauses 42 to 50, wherein the non-conductive solar control coating is reflective to electromagnetic radiation having a wavelength in the ultraviolet radiation region.

Clause 52: The article of any one of clauses 42 to 51, wherein the article exhibits a luminous transmittance using standard illuminate A (LTA) of at least 70%.

Clause 53: The article of any one of clauses 42 to 52, further comprising a protective overcoat over at least a portion of the non-conductive solar control coating.

Clause 54: The article of clause 53, wherein the protective overcoat comprises SiAlO.

Clause 55: The article of any one of clauses 42 to 54, wherein the glass substrate is a soda-lime glass.

Clause 56: The article of any one of clauses 42 to 55, further comprising a second glass substrate opposite the first glass substrate having a No. 3 surface and a No. 4 surface opposite the No. 3 surface.

Clause 57: The article of any one of clauses 42 to 56, wherein the article is an automotive component.

Clause 58. The article of clause 57, wherein the automotive component is a windshield, a sidelite, a backlite, or sunroof.

Clause 59: An article comprising: a glass substrate having a No. 1 surface and a No. 2 surface opposite the No. 1 surface; and a non-conductive solar control coating on the No. 1 surface or the No. 2 surface comprising a plurality of dielectric layers, wherein the coating comprises an alternating stack of low refractive index material layers and medium refractive index material layers comprising: a first dielectric layer having a low refractive index; a second dielectric layer over the first dielectric layer having a medium refractive index; a third dielectric layer over the second dielectric layer having a low refractive index; a fourth dielectric layer over the third dielectric layer having a medium refractive index; a fifth dielectric layer over the fourth dielectric layer having a low refractive index; a sixth dielectric layer over the fifth dielectric layer having a medium refractive index; a seventh dielectric layer over the sixth dielectric layer having a low refractive index; an eighth dielectric layer over the seventh dielectric layer having a medium refractive index; and a ninth dielectric layer over the eighth dielectric layer having a low refractive index.

Clause 60: The article of clause 59, wherein the medium refractive index layers have a thickness of about 8 nanometers (nm) to about 20 nm, such as from 9 nm to 18 nm, or such as from 9.5 nm to 15 nm.

Clause 61: The article of clause 59 or 60, wherein the medium refractive index layers comprise zinc stannate.

Clause 62: The article of any one of clauses 59 to 61, wherein the low refractive index material layers each separately comprises a low refractive index material selected from the group consisting of silica, alumina, silicon aluminum oxide (SiAlO), alloys thereof, and combinations thereof.

Clause 63: The article of any one of clauses 59 to 62, wherein the low refractive index material layers each comprise SiAlO.

Clause 64: The article of any one of clauses 59 to 63, wherein the non-conductive solar control coating has a total thickness of about 1100 nm to about 1600 nm,, such as from 1125 nm to 1300 nm, or such as from 1150 nm to 1200 nm

Clause 65: The article of any one of clauses 59 to 64, wherein the non-conductive solar control coating is reflective to electromagnetic radiation having a wavelength in the infrared radiation region.

Clause 66: The article of any one of clauses 59 to 65, wherein the non-conductive solar control coating is reflective to electromagnetic radiation having a wavelength in the ultraviolet radiation region.

Clause 67: The article of any one of clauses 59 to 66, wherein the article exhibits a luminous transmittance using standard illuminate A (LTA) of at least 70%.

Clause 68: The article of any one of clauses 59 to 67, further comprising a protective overcoat over at least a portion of the non-conductive solar control coating.

Clause 69: The article of clause 68, wherein the protective overcoat comprises SiAlO.

Clause 70: The article of any one of clauses 59 to 69, wherein the glass substrate is a soda-lime glass.

Clause 71: The article of any one of clauses 59 to 70, further comprising a second glass substrate opposite the first glass substrate having a No. 3 surface and a No. 4 surface opposite the No. 3 surface.

Clause 72: The article of any one of clauses 59 to 71, wherein the article is an automotive component.

Clause 73: The article of clause 72, wherein the automotive component is a windshield, a sidelite, a backlite, or sunroof.

Clause 74: An article comprising: a glass substrate having a No. 1 surface and a No. 2 surface opposite the No. 1 surface; and a non-conductive solar control coating on the No. 1 surface or the No. 2 surface comprising a plurality of dielectric layers, wherein the coating comprises an alternating stack of medium refractive index material layers and high refractive index material layers comprising: a first dielectric layer having a medium refractive index; a second dielectric layer over the first dielectric layer having a high refractive index; a third dielectric layer over the second dielectric layer having a medium refractive index; a fourth dielectric layer over the third dielectric layer having a high refractive index; a fifth dielectric layer over the fourth dielectric layer having a medium refractive index; a sixth dielectric layer over the fifth dielectric layer having a high refractive index; a seventh dielectric layer over the sixth dielectric layer having a medium refractive index; an eighth dielectric layer over the seventh dielectric layer having a high refractive index; and a ninth dielectric layer over the eighth dielectric layer having a medium refractive index.

Clause 75: The article of clause 74, wherein the medium refractive index layers have a thickness of about 8 nanometers (nm) to about 20 nm, such as from 9 nm to 18 nm, or such as from 9.5 nm to 15 nm.

Clause 76: The article of clause 74 or 75, wherein the medium refractive index layers comprise zinc stannate.

Clause 77: The article of any one of clauses 74 to 76, wherein the high refractive index material layers each separately comprise a high refractive index material selected from the group consisting of titania, zirconia, silicon zirconium nitride, niobium oxide, bismuth oxide, tungsten oxide, and mixtures thereof.

Clause 78: The article of any one of clauses 74 to 77, wherein the non-conductive solar control coating has a total thickness of about 1100 nm to about 1600 nm, such as from 1125 nm to 1300 nm, or such as from 1150 nm to 1200 nm.

Clause 79: The article of any one of clauses 74 to 78, wherein the non-conductive solar control coating is reflective to electromagnetic radiation having a wavelength in the infrared radiation region.

Clause 80: The article of any one of clauses 74 to 79, wherein the non-conductive solar control coating is reflective to electromagnetic radiation having a wavelength in the ultraviolet radiation region.

Clause 81: The article of any one of clauses 74 to 80, wherein the article exhibits a luminous transmittance using standard illuminate A (LTA) of at least 70%.

Clause 82: The article of any one of clauses 74 to 81, further comprising a protective overcoat over at least a portion of the non-conductive solar control coating.

Clause 83: The article of clause 82, wherein the protective overcoat comprises SiAlO.

Clause 84: The article of any one of clauses 74 to 83, wherein the glass substrate is a soda-lime glass.

Clause 85: The article of any one of clauses 74 to 84, further comprising a second glass substrate opposite the first glass substrate having a No. 3 surface and a No. 4 surface opposite the No. 3 surface.

Clause 86: The article of any one of clauses 74 to 85, wherein the article is an automotive component.

Clause 87: The article of clause 86, wherein the automotive component is a windshield, a sidelite, a backlite, or sunroof.

The following Examples illustrate various embodiments of the invention. However, it is to be understood that the invention is not limited to these specific embodiments.

Table 1 shows exemplary Samples 1-4 of the invention. The reported thickness are the physical thicknesses in nanometers (nm). The substrates were 3.9 mm thick. Samples 1-4 had alternating layers of titania (TiO₂) and silicon aluminum oxide (SiAlO). The SiAlO layers were deposited using an 85 wt. % silicon and 15 wt. % aluminum target.

TABLE 1

| | Sample 1 | Sample 2 | Sample 3 | Sample 4 |
|---|---|---|---|---|
| Substrate | Clear | Clear | Solexia ® | Atlantica ® |
| | Glass | Glass | Glass | Glass |
| TiO₂ | 113.55 nm | 108.28 nm | 140.79 nm | 14.33 nm |
| SiAlO | 186.72 nm | 139.36 nm | 182.16 nm | 196.02 nm |
| TiO₂ | 151.26 nm | 44.15 nm | 198.4 nm | 156.52 nm |
| SiAlO | 20.12 nm | 165.77 nm | 159.7 nm | 19.5 nm |
| TiO₂ | 154.98 nm | 112.83 nm | 69.45 nm | 57.36 nm |
| SiAlO | 115.91 nm | 197.75 nm | 134.17 nm | 185.86 nm |
| TiO₂ | 200 nm | 123.83 nm | 109.2 nm | 193.35 nm |
| SiAlO | 151.5 nm | 189.36 nm | 63.74 nm | 200 nm |
| TiO₂ | 82.2 nm | 102.49 nm | 96.71 nm | 140.37 nm |
| Total Thickness | 1176.24 nm | 1183.8 nm | 1154.32 nm | 1163.3 nm |

The resulting optical properties of Samples 1-4 can be found in Table 2. LTA is the luminous transmittance using standard illuminate A, Tsolar is percentage of solar energy that is transmitted, Rsolar is percent of solar energy that is reflected, TTS is the transmission of total solar energy, 8-Rfa is the film side (interior) reflected a* at an 8 degree angle, 8-Rfb is the film side (interior) reflected b* at an 8 degree angle, 8-RfY is the film side (interior) reflected Y at an 8 degree angle, 8-TY is the transmitted Y at an 8 degree angle, 8-Rga is the glass side (exterior) reflected a* at an 8 degree angle, and 8-Rgb is the glass side (exterior) reflected b* at an 8 degree angle.

TABLE 2

| | Sample 1 | Sample 2 | Sample 3 | Sample 4 |
|---|---|---|---|---|
| LTA (%) | 70.0 | 64.5 | 70.0 | 65.7 |
| Tsolar | 43 | 43.1 | 38.0 | 31.9 |
| Rsolar | 38.7 | 37 | 23.6 | 13.2 |
| TTS | 48.0 | 48.1 | 48.6 | 47.0 |
| 8-Rfa | −0.45 | 1.2 | −2.6 | 12.5 |
| 8-Rfb | −28.2 | −13.9 | −25.9 | −43.0 |
| 8-RfY | 29.1 | 34.8 | 23.3 | 19.4 |
| 8-TY | 67.8 | 62.9 | 69.6 | 68.4 |
| 8-Rga | −2.5 | −1.1 | −5.1 | 4.1 |
| 8-Rgb | −27.8 | −13.8 | −13.8 | −33.1 |

Samples 1-4 provided a highly chromatic color for most incidence angles and reached TTS levels of double silver low-emissivity coatings.

### Example 2

Table 3 shows exemplary Sample 5 of the invention. The reported thickness are the physical thicknesses in nanometers (nm). The substrate was 3.9 mm thick. Sample 5 had layers of zinc stannate (ZnSn), titania (TiO₂), and silicon aluminum oxide (SiAlO). The SiAlO layers were deposited using an 85 wt. % silicon and 15 wt. % aluminum target.

TABLE 3

| Layer | Sample 5 |
|---|---|
| Substrate | Clear Glass |
| ZnSn | 10.16 nm |
| TiO₂ | 82.55 nm |
| SiAlO | 157.14 nm |
| TiO₂ | 74.58 nm |
| SiAlO | 195.19 nm |
| TiO₂ | 111.91 nm |
| SiAlO | 188.24 nm |
| TiO₂ | 95.38 nm |
| SiAlO | 152.95 nm |
| TiO₂ | 82.51 nm |
| SiAlO | 176.63 nm |
| TiO₂ | 64.9 nm |
| ZnSn | 10 nm |
| TiO₂ | 177.88 nm |
| Total Thickness | 1580.0 nm |

The resulting optical properties of Sample 5 can be found in Table 4.

TABLE 4

| | Sample 5 |
|---|---|
| LTA (%) | 70.0 |
| Tsolar | 42.6 |
| Rsolar | 38.0 |
| TTS | 47.9 |
| 8-Rfa | −6.5 |
| 8-Rfb | −8.0 |
| 8-RfY | 29.4 |
| 8-TY | 68.4 |
| 8-Rga | −7.9 |
| 8-Rgb | −8.1 |

Sample 5 provided a highly chromatic color for most incidence angles and reached a TTS level of double silver low-emissivity coatings.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An article comprising:
a glass substrate having a No. 1 surface and a No. 2 surface opposite the No. 1 surface; and
a non-conductive solar control coating on the No. 1 surface or the No. 2 surface comprising a plurality of dielectric layers,
wherein the non-conductive solar control coating comprises an alternating stack of high refractive index material layers and low refractive index material layers.

2. The article of claim 1, wherein the low refractive index material layers have a refractive index of less than 1.7.

3. The article of claim 1, wherein there are no more than ten high refractive index material layers in the non-conductive solar control coating.

4. The article of claim 1, wherein there are no more than ten low refractive index material layers in the non-conductive solar control coating.

5. The article of claim 1, wherein the non-conductive solar control coating further comprises at least one medium refractive index material, wherein the at least one medium refractive index material comprises zinc stannate, and wherein the at least one medium refractive index material has a thickness of about 8 nanometers (nm) to about 20 nm.

6. The article of claim 1, wherein the high refractive index material layers each separately comprise a high refractive index material selected from the group consisting of titania, zirconia, silicon zirconium nitride, niobium oxide, bismuth oxide, tungsten oxide, and mixtures thereof.

7. The article of claim 1, wherein the article exhibits a luminous transmittance using standard illuminate A (LTA) of at least 70%.

8. The article of claim 1, wherein the high refractive index material layers comprise:
a first dielectric layer having a first refractive index;
a third dielectric layer having a third refractive index; and
a fifth dielectric layer having a fifth refractive index, and
wherein the low refractive index material layers comprise:
a second dielectric layer having a second refractive index positioned over at least a portion of the first dielectric layer; and
a fourth dielectric layer having a fourth refractive index positioned over the third dielectric layer,
wherein the first refractive index is higher than the second refractive index,
wherein the third refractive index is higher than the second refractive index, and
wherein the fifth refractive index is higher than the fourth refractive index.

9. The article of claim 8, wherein the first dielectric layer and the third dielectric layer comprise a first material and the second dielectric layer comprises a second material that is different than the first material.

10. The article of claim 1, further comprising a protective overcoat over at least a portion of the non-conductive solar control coating.

11. The article of claim 1, further comprising a second glass substrate opposite the first glass substrate having a No. 3 surface and a No. 4 surface opposite the No. 3 surface.

12. The article of claim 1, wherein the non-conductive solar control coating has a total thickness of about 1100 nm to about 2400 nm.

13. An article comprising:
a glass substrate having a No. 1 surface and a No. 2 surface opposite the No. 1 surface; and
a non-conductive solar control coating on the No. 1 surface or the No. 2 surface comprising a plurality of dielectric layers,
wherein the non-conductive solar control coating comprises an alternating stack of high refractive index material layers and low refractive index material layers comprising:
a first dielectric layer having a high refractive index;
a second dielectric layer over the first dielectric layer having a low refractive index;
a third dielectric layer over the second dielectric layer having a high refractive index;
a fourth dielectric layer over the third dielectric layer having a low refractive index;
a fifth dielectric layer over the fourth dielectric layer having a high refractive index;
a sixth dielectric layer over the fifth dielectric layer having a low refractive index;
a seventh dielectric layer over the sixth dielectric layer having a high refractive index;
an eighth dielectric layer over the seventh dielectric layer having a low refractive index; and
a ninth dielectric layer over the eighth dielectric layer having a high refractive index.

14. The article of claim 13, wherein the high refractive index material layers each separately comprise a high refractive index material selected from the group consisting of titania, zirconia, silicon zirconium nitride, niobium oxide, bismuth oxide, tungsten oxide, and mixtures thereof.

15. The article of claim 13, wherein the non-conductive solar control coating has a total thickness of about 1100 nm to about 1600 nm.

16. The article of claim 13, further comprising at least one dielectric layer having a medium refractive index, wherein the at least one dielectric layer having a medium refractive index comprises zinc stannate.

17. An article comprising:
a glass substrate having a No. 1 surface and a No. 2 surface opposite the No. 1 surface; and
a non-conductive solar control coating on the No. 1 surface or the No. 2 surface comprising a plurality of dielectric layers,
wherein the non-conductive solar control coating comprises an alternating stack of high refractive index material layers and low refractive index material layers comprising:
a first dielectric layer having a medium refractive index;
a second dielectric layer over the first dielectric layer having a high refractive index;
a third dielectric layer over the second dielectric layer having a low refractive index;
a fourth dielectric layer over the third dielectric layer having a high refractive index;
a fifth dielectric layer over the fourth dielectric layer having a low refractive index;
a sixth dielectric layer over the fifth dielectric layer having a high refractive index;
a seventh dielectric layer over the sixth dielectric layer having a low refractive index;
an eighth dielectric layer over the seventh dielectric layer having a high refractive index;
a ninth dielectric layer over the eighth dielectric layer having a low refractive index;
a tenth dielectric layer over the ninth dielectric layer having a high refractive index;
an eleventh dielectric layer over the tenth dielectric layer having a low refractive index;
a twelfth dielectric layer over the eleventh dielectric layer having a high refractive index;
a thirteenth dielectric layer over the twelfth dielectric layer having a medium refractive index; and
a fourteenth dielectric layer over the thirteenth dielectric layer having a high refractive index.

18. The article of claim 17, wherein the first dielectric layer and the thirteenth dielectric layer comprise zinc stannate.

19. The article of claim 17, wherein the non-conductive solar control coating has a total thickness of about 1100 nm to about 1600 nm.

20. The article of claim 17, wherein the high refractive index material layers each separately comprise a high refractive index material selected from the group consisting of titania, zirconia, silicon zirconium nitride, niobium oxide, bismuth oxide, tungsten oxide, and mixtures thereof.
